(19) United States
(12) Patent Application Publication
(10) Pub. No.: US 2024/0397304 A1
(43) Pub. Date: Nov. 28, 2024

(54) DIALING METHOD AND APPARATUS, AND ELECTRONIC DEVICE

(71) Applicant: VIVO MOBILE COMMUNICATION CO., LTD., Dongguan (CN)

(72) Inventors: Xu LIU, Dongguan (CN); Limin WANG, Dongguan (CN)

(73) Assignee: VIVO MOBILE COMMUNICATION CO., LTD., Dongguan (CN)

(21) Appl. No.: 18/796,545

(22) Filed: Aug. 7, 2024

Related U.S. Application Data
(63) Continuation of application No. PCT/CN2023/075008, filed on Feb. 8, 2023.

(30) Foreign Application Priority Data
Feb. 9, 2022 (CN) 202210122956.3

(51) Int. Cl. H04W 8/18

(52) U.S. Cl. CPC H04W 8/183

(57) ABSTRACT

This application discloses a dialing method and apparatus, and an electronic device. The dialing method includes: receiving, when a target device is connected to an electronic device, dialing request information sent by the target device, where the dialing request information is used for requesting the electronic device to dial; determining a first subscriber identity module card in the electronic device based on a historically successful call card selection status of the electronic device; and using the first subscriber identity module card to dial.

### CROSS-REFERENCE TO RELATED APPLICATIONS

This application is a continuation of International Application No. PCT/CN2023/075008, filed Feb. 8, 2023, which claims priority to Chinese Patent Application No. 202210122956.3, filed Feb. 9, 2022. The entire contents of each of the above-referenced applications are expressly incorporated herein by reference.

### TECHNICAL FIELD

This application relates to the field of communication technologies, and specifically, to a dialing method and apparatus, and an electronic device.

### BACKGROUND

With the development of electronic devices, electronic devices have increasingly rich functions. For example, an electronic device may be triggered through a third-party device (for example, a smart watch) to make a call.

In related technologies, if a user needs to trigger, through a third-party device, an electronic device to make a call, the user may perform an input on the third-party device to trigger the electronic device to dial using a card defaulted by a system (for example, a SIM card) or a card most recently used to dial the same number.

However, according to the foregoing method, when the electronic device needs to be triggered by the third-party device to make a call, dialing is performed by using the card defaulted by the system or the card most recently used to dial the same number. Therefore, if a card selected by the electronic device is an invalid card (for example, the card is in arrears or has been canceled) or an IoT card, the dialing fails, leading to a high probability of failure to trigger dialing of the electronic device through the third-party device.

### SUMMARY

The purpose of embodiments of this application is to provide a dialing method and apparatus, and an electronic device.

According to a first aspect, an embodiment of this application provides a dialing method. The method includes: receiving, in a case that a target device is connected to an electronic device, dialing request information sent by the target device, where the dialing request information is used for requesting the electronic device to dial; determining a first subscriber identity module card in the electronic device based on a historically successful call card selection status of the electronic device; and using the first subscriber identity module card to dial.

According to a second aspect, an embodiment of this application provides a dialing apparatus. The apparatus includes: a receiving module, a determining module, and a processing module, where the receiving module is configured to receive, in a case that a target device is connected to an electronic device, dialing request information sent by the target device, where the dialing request information is used for requesting the electronic device to dial; the determining module is configured to determine, in response to the dialing request information received by the receiving module, a first subscriber identity module card in the electronic device based on a historically successful call card selection status of the electronic device; and the processing module is configured to use the first subscriber identity module card determined by the determining module to dial.

According to a third aspect, an embodiment of this application provides an electronic device. The electronic device includes a processor, a memory, and a program or instructions stored in the memory and executable on the processor, where the program or the instructions, when executed by the processor, implement the steps of the method according to the first aspect.

According to a fourth aspect, an embodiment of this application provides a readable storage medium, storing a program or instructions, where the program or the instructions, when executed by a processor, implement the steps of the method according to the first aspect.

According to a fifth aspect, an embodiment of this application provides a chip. The chip includes a processor and a communication interface. The communication interface is coupled to the processor. The processor is configured to run a program or instructions to implement the method according to the first aspect.

According to a sixth aspect, an embodiment of this application provides a computer program product, where the program product is stored in a storage medium, and the program product is executed by at least one processor to implement the method according to the first aspect.

In this embodiment of this application, in a case that the target device is connected to the electronic device, the electronic device may receive the dialing request information sent by the target device, where the dialing request information is used for requesting the electronic device to dial; determine the first subscriber identity module card in the electronic device based on the historically successful call card selection status of the electronic device; and use the first subscriber identity module card to dial. According to this solution, after the electronic device receives the dialing request information sent by the target device, the electronic device can dial by using the first subscriber identity module card determined by the electronic device based on the historically successful call card selection status. Therefore, compared with the solution in current technologies that the electronic device dials by using the card defaulted by the system or the card most recently used to dial the same number, the dialing method provided in embodiments of this application can improve the probability of successful calls of the electronic device.

### BRIEF DESCRIPTION OF THE DRAWINGS

FIG. 1 is a flowchart of a dialing method according to an embodiment of this application;

FIG. 2 is a schematic diagram of a dialing apparatus according to an embodiment of this application;

FIG. 3 is a schematic diagram of an electronic device according to an embodiment of this application; and

FIG. 4 is a schematic diagram of hardware of an electronic device according to an embodiment of this application.

### DETAILED DESCRIPTION

The technical solutions in embodiments of this application are clearly described below with reference to the accompanying drawings in embodiments of this application. Apparently, the described embodiments are some rather than all of embodiments of this application. All other embodiments obtained by a person of ordinary skill in the art based on embodiments of this application fall within the protection scope of this application.

The specification and claims of this application, and terms “first” and “second” are used to distinguish similar objects, but are not used to describe a specific sequence or order. It should be understood that the terms termed in this way are interchangeable in a proper case, so that embodiments of this application can be implemented in other orders than the orders illustrated or described herein. Moreover, the objects distinguished by “first” and “second” are usually of one type, and the quantity of objects is not limited. For example, there may be one or more first objects. In addition, “and/or” in the description and claims represents at least one of connected objects, and the character “/” generally indicates an “or” relationship between associated objects.

It should be noted that identifiers in embodiments of this application indicate text, symbols, images, and the like of information. Controls or other containers may be used as carriers to display information, including but not limited to text identifiers, symbol identifiers, and image identifiers.

First, some terms involved in the claims and description of this application are explained below.

Integrated circuit card identity (ICCID): ICCID is a unique identification number of a subscriber identity module card, and is equivalent to an identity card of the subscriber identity module card.

A dialing method and apparatus, and an electronic device provided in embodiments of this application are described in detail below with reference to the accompanying drawings by using specific embodiments and application scenarios.

The dialing method provided in embodiments of the present application may be applied in a scenario where a user triggers dialing of an electronic device through a third-party device.

For example, in a case that a third-party device (for example, a target device in this embodiment) is connected to the electronic device, when the user needs to trigger dialing of the electronic device through the target device, the user may trigger, through an input on the target device, the target device to send dialing request information to the electronic device, where the dialing request information is used for requesting the electronic device to dial. The electronic device may then determine a first subscriber identity module card in the electronic device based on a historically successful call card selection status of the electronic device; and use the first subscriber identity module card to dial. Therefore, compared with the solution in current technologies that the electronic device dials by using the card defaulted by the system or the card most recently used to dial the same number, the dialing method provided in embodiments of this application can reduce a probability of failure to trigger dialing of the electronic device through the third-party device.

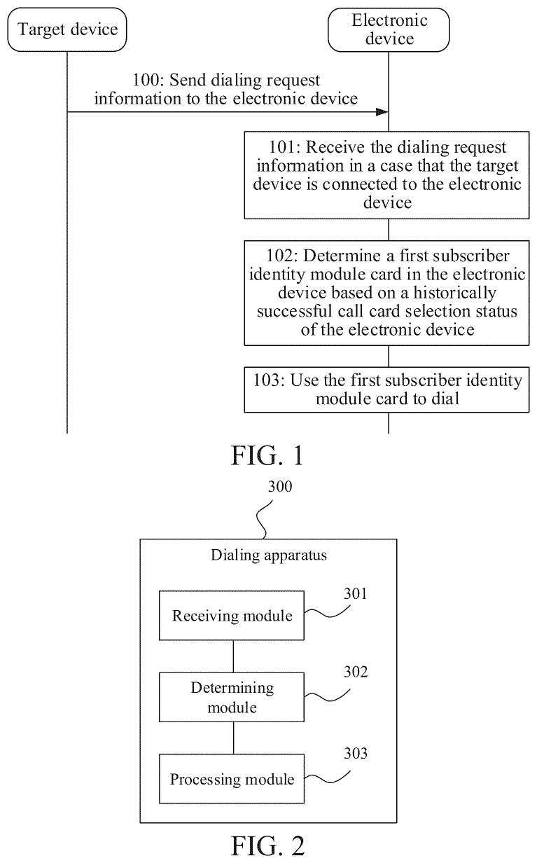

Refer to FIG. 1. An embodiment of this application provides a dialing method. The method may include the following steps 100 to 103.
Step 100: A target device sends dialing request information to an electronic device.
Step 101: In a case that the target device is connected to the electronic device, the electronic device receives dialing request information.

The dialing request information may be used for requesting the electronic device to dial.

In some embodiments of this application, the target device may be triggered by the user to send the dialing request information to the electronic device for requesting the electronic device to dial. Therefore, the electronic device may receive the dialing request information, and dial based on the dialing request information.

In some embodiments of this application, the target device may be any possible device such as a wearable device (for example, a smart watch), an in-vehicle device, or a mobile phone. This may be determined according to actual usage requirements, and is not limited in this embodiment of this application.

In some embodiments of this application, the target device and the electronic device may be connected through a wireless network or a wired network, so that the target device can send the dialing request information to the electronic device.

For example, the target device may be a smart watch, and the smart watch may be connected to the electronic device through a Bluetooth network.
Step 102: The electronic device determines a first subscriber identity module card in the electronic device based on a historically successful call card selection status of the electronic device.

In some embodiments of this application, the electronic device may obtain the historically successful call card selection status in a historical call record, to determine the first subscriber identity module card in the electronic device; or the electronic device may determine the first subscriber identity module card in the electronic device based on information stored in a storage area (for example, at least one storage area in this embodiment). This may be determined according to actual usage requirements, and is not limited in this embodiment of this application.
Step 103: The electronic device uses the first subscriber identity module card to dial.

In some embodiments of this application, the first subscriber identity module card may be any one of the following: a subscriber identity module card used for a most recent successful call of the electronic device, or a subscriber identity module card with a highest historically successful call frequency.

In this embodiment of this application, the electronic device may include a plurality of subscriber identity module cards, and the plurality of subscriber identity module cards include the first subscriber identity module card.

It may be understood that a successful call by the electronic device through a subscriber identity module card may include any of the following situations: 1. The electronic device successfully sends call request information to an other-party device through the subscriber identity module card. 2. The electronic device receives, through the subscriber identity module card, call request information sent by an other-party device.

In some embodiments of this application, a historically successful call frequency of a subscriber identity module card may be a total number of successful calls made by the electronic device through the subscriber identity module card within a preset historical time period.

The preset historical time period may be preset by the user or defaulted by the system. This may be determined according to actual usage requirements, and is not limited in this embodiment of this application.

In this embodiment of this application, that the electronic device uses the first subscriber identity module card to dial may be: the electronic device uses the first subscriber identity module card to dial through a channel corresponding to a card slot in which the first subscriber identity module card is located.

In this embodiment of this application, the first subscriber identity module card may be any one of a subscriber identity module card used for a most recent successful call of the electronic device or a subscriber identity module card with a highest historically successful call frequency. Therefore, compared with the solution in current technologies that dialing is performed by using the card most recently used to dial the same number, the dialing method provided in embodiments of this application can improve the probability of successful calls of the electronic device.

### One Implementation

In some embodiments of this application, the foregoing step 102 may be implemented through the following step 102a.
Step 102a: The electronic device determines a subscriber identity module card indicated by a card slot identifier stored in a target storage area as the first subscriber identity module card.

The target storage area may be a storage area in at least one storage area of the electronic device, and each storage area may be used for storing a card slot identifier corresponding to the subscriber identity module card used for the most recent successful call of the electronic device, or a card slot identifier corresponding to the subscriber identity module card with the highest historically successful call frequency.

In some embodiments of this application, a card identifier of a subscriber identity module card may be an ICCID corresponding to the subscriber identity module card, a phone number corresponding to the subscriber identity module card, or the like. For a detailed description of the ICCID, refer to the related description of the ICCID in the foregoing term description part.

### Another Implementation

In some embodiments of this application, the electronic device may record, in a call record, a card identifier of a subscriber identity module card and a card slot identifier of a card slot in which the subscriber identity module card is located. Therefore, the electronic device may determine, based on the call record, a subscriber identity module card used for the most recent successful call of the electronic device and a card slot in which the subscriber identity module card is located; or the electronic device may determine, based on the call record, a subscriber identity module card with the highest historically successful call frequency in the electronic device and a card slot in which the subscriber identity module card is located.

In some embodiments of this application, the electronic device may use the subscriber identity module card used for the most recent successful call of the electronic device to dial, or may use the subscriber identity module card with the highest historically successful call frequency of the electronic device to dial. This may be determined according to actual usage requirements, and is not limited in this embodiment of this application.

In this embodiment of this application, the electronic device may determine the subscriber identity module card indicated by the card slot identifier stored in the storage area storing the card slot identifier corresponding to the subscriber identity module card used for the most recent successful call of the electronic device, or stored in the storage area storing the card slot identifier corresponding to the subscriber identity module card with the highest historically successful call frequency as the first subscriber identity module card. Therefore, a speed at which the electronic device determines the first subscriber identity module card can be increased, thereby shortening response duration of the electronic device, and further improving user experience.

According to the dialing method provided in this embodiment of this application, in a case that the target device is connected to the electronic device, the electronic device may receive the dialing request information sent by the target device, where the dialing request information is used for requesting the electronic device to dial; determine the first subscriber identity module card in the electronic device according to the historically successful call card selection status of the electronic device; and use the first subscriber identity module card to dial. Therefore, compared with the solution in current technologies that the electronic device dials by using the default card of the system or the most recently used to dial the same number, the dialing method provided in embodiments of this application can improve the probability of successful calls of the electronic device.

In some embodiments of this application, the dialing request information may include a contact identifier, and the contact identifier may be a phone number of a contact and/or a card identifier of a subscriber identity module card of the contact. Therefore, after receiving the dialing request information, the electronic device may send call request information to the contact, where the call request information is used for requesting a call with the contact.

In some embodiments of this application, assuming that the dialing request information is used for requesting to dial a target contact, the foregoing step 102 may be implemented through the following step 102b.
Step 102b: The electronic device determines a subscriber identity module card used by the electronic device for a most recent successful call with the target contact as the first subscriber identity module card.

For example, it is assumed that the subscriber identity module card used by the electronic device for the most recent successful call with the target contact is a subscriber identity module card 1. In this case, when the electronic device receives the dialing request information for requesting to dial the target contact, the electronic device may directly use the subscriber identity module card 1 to dial the target contact.

In some embodiments of this application, in the one implementation above, for each contact having a successfully call with the electronic device, the electronic device may associate and store a contact identifier of a contact with a card identifier and a card slot identifier. The card identifier is a card identifier of a subscriber identity module card used by the electronic device for a most recent successful call with the contact. The card slot identifier is a card slot identifier of a card slot in which the subscriber identity module card is located. Each contact having a successfully call with the electronic device corresponds to a storage area. Therefore, after receiving dialing request information, the electronic device may find, based on a contact identifier in the dialing request information, a storage area corresponding to the contact identifier, determine a subscriber identity module card indicated by a card identifier in the storage area as a first subscriber identity module card, and use a card slot indicated by a card slot identifier in the storage area as a card slot in which the first subscriber identity module card is located. This can increase the speed at which the electronic device determines the first subscriber identity module card.

In the another implementable above, the electronic device may find, based on the contact identifier in the received dialing request information, a record of the most recent successful call between the electronic device and the target contact from the call record, use the subscriber identity module card indicated by the card identifier in the call record as the first subscriber identity module card, and determine the card slot indicated by the card slot identifier in the call record as the card slot in which the first subscriber identity module card is located.

In this embodiment of this application, for each contact, the electronic device may dial the contact by using a subscriber identity module card used by the electronic device for a most recent successful call with a contact. Therefore, compared with the solution in current technologies that dialing is performed by using the card most recently used to dial the same number, the dialing method provided in embodiments of this application can improve the probability of successful calls of the electronic device.

In some embodiments of this application, the foregoing step 103 may be implemented through the following step 103a.
Step 103a: In a case that the first subscriber identity module card is a call service registered state, the electronic device uses the first subscriber identity module card to dial.

In some embodiments of this application, after determining the first subscriber identity module card, the electronic device may first determine whether the first subscriber identity module card is in the call service registered state. If the first subscriber identity module card is in the call service registered state, the electronic device may use the first subscriber identity module card to dial; or if the first subscriber identity module card is in a call service unregistered state, the electronic device may use another subscriber identity module card in the electronic device to dial.

In some embodiments of this application, that the first subscriber identity module card is in the call service registered state may include at least one of the following cases: the first subscriber identity module card is in an International Internet Protocol (IP) multimedia subsystem IMS (IP Multimedia Subsystem, IMS) registered state, the first subscriber identity module card is in a long-term evolution voice bearer Volte registered state, or the first subscriber identity module card is in a voice service Voice registered state.

In some embodiments of this application, that the first subscriber identity module card is in the call service unregistered state is that: the first subscriber identity module card is not registered with IMS, Volte, and Voice.

In this embodiment of this application, the electronic device may dial by using the first subscriber identity module card when the first subscriber identity module card is in the call service registered state. Therefore, it can be ensured that the electronic device can successfully dial by using the first subscriber identity module card.

In some embodiments of this application, the electronic device includes a plurality of subscriber identity module cards. After the foregoing step 101, the dialing method provided in this embodiment of this application may further include step 104.
Step 104: In a case that the target storage area does not include a card slot identifier, the electronic device uses a second subscriber identity module card to dial.

The second subscriber identity module card may be any of the following A or B.
A: A subscriber identity module card with highest signal strength in the plurality of subscriber identity module cards.

In this embodiment of this application, the electronic device can use the subscriber identity module card with the highest signal strength in the plurality of subscriber identity module cards to dial, so that the probability of successful dialing by the electronic device can be improved.
B: A subscriber identity module card determined by the electronic device based on call service registered states of the plurality of subscriber identity module cards.

For ease of description, an example in which the plurality of subscriber identity module cards are two subscriber identity module cards is used for illustration. The same applies to three or more subscriber identity module cards. To avoid repetition, details are not described herein again.

For example, the electronic device may first detect whether a subscriber identity module card 1 in a first card slot is in an IMS registered state or a Volte registered state. If the subscriber identity module card 1 is in the IMS registered state or the Volte registered state, the electronic device may use the subscriber identity module card 1 (namely, the second subscriber identity module card) to dial. If the subscriber identity module card 1 is in an IMS unregistered state and a Volte unregistered state, the electronic device may continue to detect whether a subscriber identity module card 2 in a second card slot is in the IMS registered state or the Volte registered state. If the subscriber identity module card 2 is in the IMS registered state or the Volte registered state, the electronic device may use the subscriber identity module card 2 to dial. If the subscriber identity module card 2 is in the IMS unregistered state and the Volte unregistered state, the electronic device may continue to detect whether the subscriber identity module card 1 is in the Volte registered state. If the subscriber identity module card 1 is in the Voice registered state, the electronic device uses the subscriber identity module card 1 to dial. If the subscriber identity module card 1 is not in the Voice unregistered state, the electronic device may continue to detect whether the subscriber identity module card 2 is in the Voice registered state. If the subscriber identity module card 2 is in the Voice registered state, the electronic device uses the subscriber identity module card 2 to dial. If the subscriber identity module card 2 is not in the Voice unregistered state, the electronic device uses the subscriber identity module card 1 to dial by default.

In this embodiment of this application, when the target storage area of the electronic device does not include a card identifier, the electronic device may use the subscriber identity module card with the highest signal strength in the plurality of subscriber identity module cards, or use the subscriber identity module card determined based on the call service registered states of the plurality of subscriber identity module cards, thereby increasing the probability of successful calls of the electronic device.

In some embodiments of this application, the target storage area is further used for storing a card identifier of the subscriber identity module card used for the most recent successful call of the electronic device, or a card identifier of the subscriber identity module card with the highest historically successful call frequency; and the dialing method provided in this embodiment of this application may further include step 105.
Step 105: The electronic device updates content stored in the target storage area in a case that a target condition is met.

The target condition may include at least one of the following (1), (2), or (3):
(1) The target storage area does not include a card slot identifier corresponding to a subscriber identity module card used for a current successful call.

In some embodiments of this application, that the target storage area does not include the card slot identifier corresponding to the subscriber identity module card used for the current successful call may include: a: the target storage area does not include any card slot identifier; or b: the target storage area includes a card slot identifier, but the card slot identifier in the target storage area is different from the card slot identifier corresponding to the subscriber identity module card used for the current successful call.

In some embodiments of this application, that the electronic device updates content stored in the target storage area is as follows:

In a above, the electronic device stores the card slot identifier corresponding to the subscriber identity module card used for the current successful call into the target storage area, and stores the card identifier of the subscriber identity module card used for the current successful call into the target storage area.

In b above, the electronic device may replace the card slot identifier in the target storage area with the card slot identifier corresponding to the subscriber identity module card used for the current successful call, and replace the card identifier in the target storage area with the card identifier of the subscriber identity module card used for the current successful call.
(2) The target storage area does not include a card slot identifier corresponding to a subscriber identity module card with a highest historically successful call frequency according to most recent statistics.

In some embodiments of this application, for a specific implementation process in which the electronic device updates the content stored in the target storage area in a case that the target storage area of the electronic device does not include the card slot identifier corresponding to the subscriber identity module card with the highest historically successful call frequency according to most recent statistics, refer to the implementation process in which the electronic device updates the content stored in the target storage area in a case that the target storage area of the electronic device does not include the card slot identifier corresponding to the subscriber identity module card used for the current successful call. To avoid repetition, details are not described herein again.
(3) A card slot in which a subscriber identity module card indicated by a card identifier in the target storage area is located changes.

In this embodiment of this application, it is assumed that the target storage area includes a card identifier of a subscriber identity module card and a card slot identifier of a card slot. If the electronic device detects that the subscriber identity module card 1 is transferred to another card slot, the electronic device may determine that the card slot in which the subscriber identity module card indicated by the card identifier in the target storage area is located changes. Therefore, the electronic device can replace the card slot identifier in the target storage area with the card slot identifier of another card slot. To be specific, the electronic device updates the content stored in the target storage area.

For example, the subscriber identity module card 1 indicated by the card identifier stored in the target storage area is originally installed in a card slot 1. In this case, when the subscriber identity module card 1 is transferred from the card slot 1 to a card slot 2, the electronic device may update the card slot identifier stored in the target storage area from a card slot identifier of the card slot 1 to a card slot identifier of the card slot 2, to ensure that the card slot indicated by the card slot identifier in the target storage area is the same with the card slot in which subscriber identity module card 1 is currently located.

For a detailed description of the target storage area, refer to the related description of the target storage area in the foregoing embodiment. To avoid duplication, details are not described herein again.

In this embodiment of this application, the electronic device can update the content stored in the target storage area in a case that the target storage area does not include a card slot identifier corresponding to a subscriber identity module card used for a current successful call, the target storage area does not include a card slot identifier corresponding to a subscriber identity module card with a highest historically successful call frequency according to most recent statistics, or a card slot in which a subscriber identity module card indicated by a card identifier in the target storage area is located changes. This ensures that the target storage area accurately stores the card identifier of the subscriber identity module card used for the most recent successful call of the electronic device and the card slot in which the subscriber identity module card is currently located, which can further increase the probability of successful calls of the electronic device.

In some embodiments of this application, the user may perform an input on the electronic device to trigger the electronic device to clear the content stored in the target storage area. In some embodiments, when the user triggers the electronic device to restore factory settings, the electronic device may clear the content stored in the target storage area.

It should be noted that, the dialing method provided in embodiments of this application may be executed by a dialing apparatus, or a control module in the dialing apparatus for executing the dialing method. In this embodiment of this application, the dialing apparatus provided in embodiments of this application is described by taking the dialing method performed by the dialing apparatus as an example.

Refer to FIG. 2. An embodiment of this application provides a dialing apparatus. The dialing apparatus may include: a receiving module 301, a determining module 302, and a processing module 303. The receiving module 301 may be configured to receive, in a case that a target device is connected to an electronic device, dialing request information sent by the target device, where the dialing request information is used for requesting the electronic device to dial. The determining module 302 may be configured to determine, in response to the dialing request information received by the receiving module 301, a first subscriber identity module card in the electronic device based on a historically successful call card selection status of the electronic device. The processing module 303 is configured to use the first subscriber identity module card determined by the determining module 302 to dial.

In some embodiments of this application, the first subscriber identity module card is any one of the following: a subscriber identity module card used for a most recent successful call of the electronic device, or a subscriber identity module card with a highest historically successful call frequency.

In some embodiments of this application, the determining module 302 may be further configured to determine a subscriber identity module card indicated by a card slot identifier stored in a target storage area as the first subscriber identity module card, where the target storage area is a storage area in at least one storage area of the electronic device, and each storage area is used for storing a card slot identifier corresponding to the subscriber identity module card used for the most recent successful call of the electronic device, or a card slot identifier corresponding to the subscriber identity module card with the highest historically successful call frequency.

In some embodiments of this application, the electronic device includes a plurality of subscriber identity module cards, and the processing module 302 may be further configured to: use a second subscriber identity module card to dial in a case that the target storage area does not include a card slot identifier, where the second subscriber identity module card is any one of the following: a subscriber identity module card with highest signal strength in the plurality of subscriber identity module cards, or a subscriber identity module card determined based on call service registered states of the plurality of subscriber identity module cards.

In some embodiments of this application, the apparatus may further include an updating module; the target storage area is further used for storing a card identifier of the subscriber identity module card used for the most recent successful call of the electronic device, or a card identifier of the subscriber identity module card with the highest historically successful call frequency; and the updating module is configured to update content stored in the target storage area in a case that a target condition is met, where the target condition includes at least one of the following: the target storage area does not include a card slot identifier corresponding to a subscriber identity module card used for a current successful call, the target storage area does not include a card slot identifier corresponding to a subscriber identity module card with a highest historically successful call frequency according to most recent statistics, or a card slot in which a subscriber identity module card indicated by a card identifier in the target storage area is located changes.

In some embodiments of this application, the dialing request information is used for requesting to dial a target contact; and the determining module 102 is further configured to determine a subscriber identity module card used by the electronic device for a most recent successful call with the target contact as the first subscriber identity module card.

According to the dialing apparatus provided in this embodiment of this application, in a case that the target device is connected to the electronic device, the electronic device may receive the dialing request information sent by the target device, where the dialing request information is used for requesting the electronic device to dial; determine the first subscriber identity module card in the electronic device based on the historically successful call card selection status of the electronic device; and use the first subscriber identity module card to dial. Therefore, compared with the solution in current technologies that the electronic device dials by using the card defaulted by the system or the card most recently used to dial the same number, the dialing apparatus provided in embodiments of this application can improve the probability of successful calls of the electronic device.

For details about the effects of the various implementations in this embodiment, refer to the effects of the corresponding implementations in the foregoing method embodiments, and details are not described herein again to avoid repetition.

The dialing apparatus in this embodiment of this application may be an electronic device, or may be a component such as an integrated circuit or a chip in the electronic device. The electronic device may be a terminal or another device other than a terminal. For example, the electronic device may be a mobile phone, a tablet computer, a notebook computer, a palm computer, an in-vehicle electronic device, a mobile Internet device (MID), an augmented reality (AR)/virtual reality (VR) device, a robot, a wearable device, an ultra-mobile personal computer (UMPC), a netbook, or a personal digital assistant (PDA), or may be a server, a network attached storage (NAS), a personal computer (PC), a television (TV), a teller machine, or an automated machine, which are not specifically limited in embodiments of this application.

The dialing apparatus in this embodiment of this application may be an apparatus having an operating system. The operating system may be an Android operating system, may be an ios operating system, or may be another possible operating system, and is not specifically limited in embodiments of this application.

The dialing apparatus provided in this embodiment of this application can implement the processes in the method embodiment of FIG. 1. To avoid repetition, details are not described herein again.

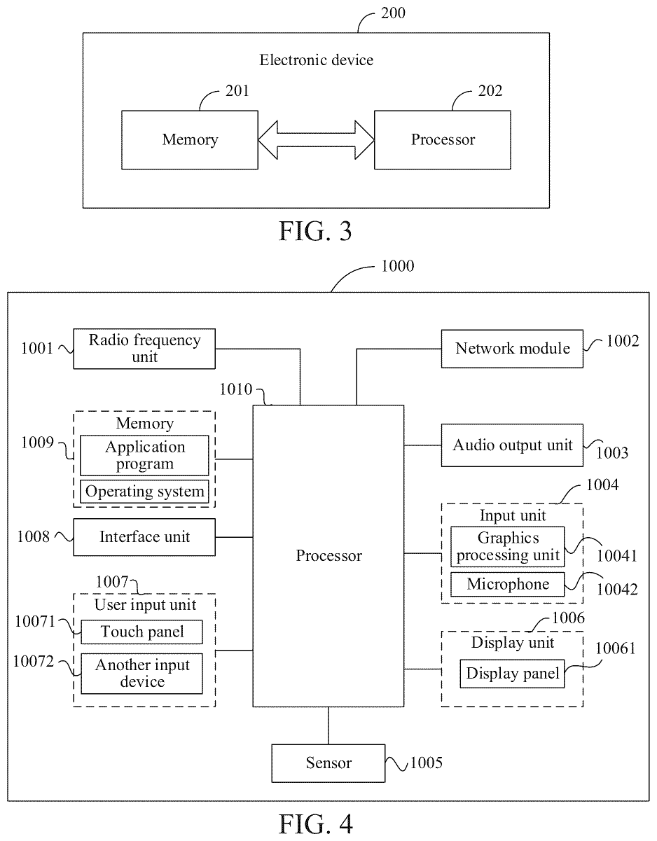

As shown in FIG. 3, an embodiment of this application further provides an electronic device 200, including a processor 202, a memory 201, and a program or instructions stored in the memory 201 and executable on the processor 202, where the program or the instructions, when executed by the processor 202, implement the processes of the embodiments of the foregoing dialing method, and can achieve the same technical effects. To avoid repetition, details are not described herein again.

It should be noted that the electronic device in embodiments of this application includes the foregoing mobile electronic device and non-mobile electronic device.

FIG. 4 is a schematic diagram of a hardware structure of an electronic device according to an embodiment of this application.

The electronic device 1000 includes, but is not limited to, components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the electronic device 1000 may further include the power supply (for example, a battery) for supplying power to the components. The power supply may be logically connected to the processor 1010 by using a power management system, thereby implementing functions such as charging, discharging, and power consumption management by using the power management system. The electronic device structure shown in FIG. 4 does not constitute a limitation to the electronic device. The electronic device may include more or fewer components than those shown in the figure, or some components may be combined, or a different component deployment may be used. Details are not described herein again.

The radio frequency unit 1001 may be configured to receive, in a case that a target device is connected to an electronic device, dialing request information sent by the target device. The processor 1010 may be configured to determine, in response to the dialing request information received by the radio frequency unit 1001, a first subscriber identity module card in the electronic device based on a historically successful call card selection status of the electronic device. The processor 1010 is further configured to use the first subscriber identity module card to dial.

In some embodiments of this application, the first subscriber identity module card is any one of the following: a subscriber identity module card used for a most recent successful call of the electronic device, or a subscriber identity module card with a highest historically successful call frequency.

In some embodiments of this application, the processor 1010 may be further configured to determine a subscriber identity module card indicated by a card slot identifier stored in a target storage area of the electronic device as the first subscriber identity module card, where the target storage area is a storage area in at least one storage area of the electronic device, and each storage area is used for storing a card slot identifier corresponding to the subscriber identity module card used for the most recent successful call of the electronic device, or a card slot identifier corresponding to the subscriber identity module card with the highest historically successful call frequency.

In some embodiments of this application, the electronic device includes a plurality of subscriber identity module cards, and the processor 1010 may be further configured to: use a second subscriber identity module card to dial in a case that the target storage area does not include a card slot identifier, where the second subscriber identity module card is any one of the following: a subscriber identity module card with highest signal strength in the plurality of subscriber identity module cards, or a subscriber identity module card determined based on call service registered states of the plurality of subscriber identity module cards.

In some embodiments of this application, the target storage area is further used for storing a card identifier of the subscriber identity module card used for the most recent successful call of the electronic device, or a card identifier of the subscriber identity module card with the highest historically successful call frequency; and the processor 1010 is further configured to update content stored in the target storage area in a case that a target condition is met, where the target condition includes at least one of the following: the target storage area does not include a card slot identifier corresponding to a subscriber identity module card used for a current successful call, the target storage area does not include a card slot identifier corresponding to a subscriber identity module card with a highest historically successful call frequency according to most recent statistics, or a card slot in which a subscriber identity module card indicated by a card identifier in the target storage area is located changes.

In some embodiments of this application, the dialing request information is used for requesting to dial a target contact; and the processor 1010 is further configured to determine a subscriber identity module card used by the electronic device for a most recent successful call with the target contact as the first subscriber identity module card.

According to the electronic device provided in this embodiment of this application, in a case that the target device is connected to the electronic device, the electronic device may receive the dialing request information sent by the target device, where the dialing request information is used for requesting the electronic device to dial; determine the first subscriber identity module card in the electronic device based on the historically successful call card selection status of the electronic device; and use the first subscriber identity module card to dial. Therefore, compared with the solution in current technologies that the electronic device dials by using the card defaulted by the system or the card most recently used to dial the same number, the electronic device provided in embodiments of this application can improve the probability of successful calls of the electronic device.

For details about the effects of the various implementations in this embodiment, refer to the effects of the corresponding implementations in the foregoing method embodiments, and details are not described herein again to avoid repetition.

It should be understood that in embodiments of this application, the input unit 1004 may include a Graphics Processing Unit (GPU) 10041 and a microphone 10042, and the graphics processing unit 10041 processes image data of still images or videos obtained by an image capture apparatus (for example, a camera) in a video capture mode or an image capture mode. The display unit 1006 may include a display panel 10061, and the display panel 10061 may be configured in a form such as a liquid crystal display or an organic light-emitting diode. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include, but is not limited to, a physical keyboard, a functional key (for example, a volume control key or a switch key), a track ball, a mouse, and a joystick, which are not repeated herein.

The memory 1009 may be configured to store a software program and various data. The memory 1009 may mainly include a first storage area storing a program or instructions and a second storage area storing data. The first storage area may store an operating system, an application program or instruction required by at least one function (for example, a sound playing function and an image playing function), and the like. In addition, the memory 1009 may include a volatile memory or a non-volatile memory, or the memory 1009 may include both a volatile and a non-volatile memory. The non-volatile memory may be a Read-Only Memory (ROM), a Programmable ROM (PROM), an Erasable PROM (EPROM), an Electrically EPROM (EEPROM) or a flash memory. The volatile memory may be a Random Access Memory (RAM), a static RAM (SRAM), a dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). The memory 1009 in this embodiment of this application includes, but is not limited to, such memories and any other suitable types of memories.

The processor 1000 may include one or more processing units. In some embodiments, the processor 1000 integrates an application processor and a modem processor. The application processor mainly processes operations related to an operating system, a user interface, an application program, and the like. The modem processor mainly processes wireless communication signals, and may be, for example, a baseband processor. It may be understood that the modem processor may not be integrated into the processor 1000.

An embodiment of this application further provides a readable storage medium. The readable storage medium stores a program or instructions, where the program or the instructions, when executed by a processor, implement the processes of embodiments of the foregoing dialing method, and achieve the same technical effects. To avoid repetition, details are not described herein again.

The processor is the processor in the electronic device described in the foregoing embodiment. The readable storage medium includes a computer-readable storage medium such as a computer read only memory ROM, a random access memory RAM, a magnetic disk, or an optical disk.

An embodiment of this application further provides a chip, where the chip includes a processor and a communication interface, the communication interface is coupled to the processor, and the processor is configured to run a program or instructions, to implement the processes of embodiments of the foregoing dialing method, and achieve the same technical effects. To avoid repetition, details are not described herein again.

It should be understood that, the chip mentioned in this embodiment of this application may also be referred to as a system-level chip, a system chip, a chip system, a system on chip, or the like.

An embodiment of this application provides a computer program product, stored in a storage medium, where the program product is executed by at least one processor to implement the processes of embodiments of the dialing method, and can achieve the same technical effects. To avoid repetition, details are not described herein again.

It should be noted that the term “include”, “include” or any other variation thereof in this specification is intended to cover a non-exclusive inclusion, which specifies the presence of stated processes, methods, objects, or apparatuses, but does not preclude the presence or addition of one or more other processes, methods, objects, or apparatuses. Without more limitations, elements defined by the sentence “including one” does not exclude that there are still other same elements in the processes, methods, objects, or apparatuses. Further, it should be noted that the scope of the method and the apparatus in the implementations of this application is not limited to performing the functions in the order shown or discussed, but may further include performing the functions in a substantially simultaneous manner or in the reverse order depending on the functions involved. For example, the described method may be performed in an order different from that described, and various steps may be further added, omitted, or combined. In addition, features described with reference to some examples may be combined in other examples.

Through the descriptions of the foregoing implementations, a person skilled in the art may clearly understand that the methods in the foregoing embodiments may be implemented via software and a necessary general hardware platform, and may also be implemented by hardware, but in many cases, the former manner is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc) and includes several instructions for instructing a terminal (which may be a mobile phone, a computer, a server, a network device, or the like) to perform the method described in embodiments of this application.

Embodiments of this application are described above with reference to the accompanying drawings. However, this application is not limited to the foregoing specific implementations. The foregoing specific implementations are illustrative instead of limitative. Enlightened by this application, a person of ordinary skill in the art can make many forms without departing from the idea of this application and the scope of protection of the claims. All of the forms fall within the protection of this application.

What is claimed is:

1. A dialing method, performed by an electronic device, comprising:
receiving, when a target device is connected to the electronic device, dialing request information sent by the target device, wherein the dialing request information is used for requesting the electronic device to dial;
determining a first subscriber identity module card in the electronic device based on a historically successful call card selection status of the electronic device; and
using the first subscriber identity module card to dial.

2. The dialing method according to claim 1, wherein the first subscriber identity module card is any one of the following: a subscriber identity module card used for a most recent successful call of the electronic device, or a subscriber identity module card with a highest historically successful call frequency.

3. The dialing method according to claim 1, wherein the determining a first subscriber identity module card in the electronic device based on a historically successful call card selection status of the electronic device comprises:
determining a subscriber identity module card indicated by a card slot identifier stored in a target storage area as the first subscriber identity module card,
wherein the target storage area is a storage area in at least one storage area of the electronic device, and each storage area is used for storing a card slot identifier corresponding to the subscriber identity module card used for the most recent successful call of the electronic device, or a card slot identifier corresponding to the subscriber identity module card with the highest historically successful call frequency.

4. The dialing method according to claim 3, wherein the electronic device comprises a plurality of subscriber identity module cards, and the method further comprises:
using a second subscriber identity module card to dial when the target storage area does not comprise a card slot identifier, wherein the second subscriber identity module card is any one of the following:
a subscriber identity module card with highest signal strength in the plurality of subscriber identity module cards, or a subscriber identity module card determined based on call service registered states of the plurality of subscriber identity module cards.

5. The dialing method according to claim 3, wherein the target storage area is further used for storing a card identifier of the subscriber identity module card used for the most recent successful call of the electronic device, or a card identifier of the subscriber identity module card with the highest historically successful call frequency; and
the method further comprises:
updating content stored in the target storage area when a target condition is met, wherein the target condition comprises at least one of the following:
the target storage area does not comprise a card slot identifier corresponding to a subscriber identity module card used for a current successful call, the target storage area does not comprise a card slot identifier corresponding to a subscriber identity module card with a highest historically successful call frequency according to most recent statistics, or a card slot in which a subscriber identity module card indicated by a card identifier in the target storage area is located changes.

6. The dialing method according to claim 1, wherein the dialing request information is used for requesting to dial a target contact; and
the determining a first subscriber identity module card in the electronic device based on a historically successful call card selection status of the electronic device comprises:
determining a subscriber identity module card used by the electronic device for a most recent successful call with the target contact as the first subscriber identity module card.

7. An electronic device, comprising: a memory storing a computer program; and a processor coupled to the memory and configured to execute the computer program to perform operations comprising:
receiving, when a target device is connected to the electronic device, dialing request information sent by the target device, wherein the dialing request information is used for requesting the electronic device to dial;
determining a first subscriber identity module card in the electronic device based on a historically successful call card selection status of the electronic device; and
using the first subscriber identity module card to dial.

8. The electronic device according to claim 7, wherein the first subscriber identity module card is any one of the following: a subscriber identity module card used for a most recent successful call of the electronic device, or a subscriber identity module card with a highest historically successful call frequency.

9. The electronic device according to claim 7, wherein the determining a first subscriber identity module card in the electronic device based on a historically successful call card selection status of the electronic device comprises:
determining a subscriber identity module card indicated by a card slot identifier stored in a target storage area as the first subscriber identity module card,
wherein the target storage area is a storage area in at least one storage area of the electronic device, and each storage area is used for storing a card slot identifier corresponding to the subscriber identity module card used for the most recent successful call of the electronic device, or a card slot identifier corresponding to the subscriber identity module card with the highest historically successful call frequency.

10. The electronic device according to claim 9, wherein the electronic device comprises a plurality of subscriber identity module cards, and the operations further comprise:
using a second subscriber identity module card to dial when the target storage area does not comprise a card slot identifier, wherein the second subscriber identity module card is any one of the following:
a subscriber identity module card with highest signal strength in the plurality of subscriber identity module cards, or a subscriber identity module card determined based on call service registered states of the plurality of subscriber identity module cards.

11. The electronic device according to claim 9, wherein the target storage area is further used for storing a card identifier of the subscriber identity module card used for the most recent successful call of the electronic device, or a card identifier of the subscriber identity module card with the highest historically successful call frequency; and
the operations further comprise:
updating content stored in the target storage area when a target condition is met, wherein the target condition comprises at least one of the following:
the target storage area does not comprise a card slot identifier corresponding to a subscriber identity module card used for a current successful call, the target storage area does not comprise a card slot identifier corresponding to a subscriber identity module card with a highest historically successful call frequency according to most recent statistics, or a card slot in which a subscriber identity module card indicated by a card identifier in the target storage area is located changes.

12. The electronic device according to claim 7, wherein the dialing request information is used for requesting to dial a target contact; and
the determining a first subscriber identity module card in the electronic device based on a historically successful call card selection status of the electronic device comprises:
determining a subscriber identity module card used by the electronic device for a most recent successful call with the target contact as the first subscriber identity module card.

13. A non-transitory computer-readable storage medium, storing a computer program, wherein the computer program, when executed by a processor of an electronic device, causes the processor to perform operations comprising:
receiving, when a target device is connected to the electronic device, dialing request information sent by the target device, wherein the dialing request information is used for requesting the electronic device to dial;
determining a first subscriber identity module card in the electronic device based on a historically successful call card selection status of the electronic device; and
using the first subscriber identity module card to dial.

14. The non-transitory computer-readable storage medium according to claim 13, wherein the first subscriber identity module card is any one of the following: a subscriber identity module card used for a most recent successful call of the electronic device, or a subscriber identity module card with a highest historically successful call frequency.

15. The non-transitory computer-readable storage medium according to claim 13, wherein the determining a first subscriber identity module card in the electronic device based on a historically successful call card selection status of the electronic device comprises:
determining a subscriber identity module card indicated by a card slot identifier stored in a target storage area as the first subscriber identity module card,
wherein the target storage area is a storage area in at least one storage area of the electronic device, and each storage area is used for storing a card slot identifier corresponding to the subscriber identity module card used for the most recent successful call of the electronic device, or a card slot identifier corresponding to the subscriber identity module card with the highest historically successful call frequency.

16. The non-transitory computer-readable storage medium according to claim 15, wherein the electronic device comprises a plurality of subscriber identity module cards, and the operations further comprise:
using a second subscriber identity module card to dial when the target storage area does not comprise a card slot identifier, wherein the second subscriber identity module card is any one of the following:
a subscriber identity module card with highest signal strength in the plurality of subscriber identity module cards, or a subscriber identity module card determined based on call service registered states of the plurality of subscriber identity module cards.

17. The non-transitory computer-readable storage medium according to claim 15, wherein the target storage area is further used for storing a card identifier of the subscriber identity module card used for the most recent successful call of the electronic device, or a card identifier of the subscriber identity module card with the highest historically successful call frequency; and
the operations further comprise:
updating content stored in the target storage area when a target condition is met, wherein the target condition comprises at least one of the following:
the target storage area does not comprise a card slot identifier corresponding to a subscriber identity module card used for a current successful call, the target storage area does not comprise a card slot identifier corresponding to a subscriber identity module card with a highest historically successful call frequency according to most recent statistics, or a card slot in which a subscriber identity module card indicated by a card identifier in the target storage area is located changes.

18. The non-transitory computer-readable storage medium according to claim 13, wherein the dialing request information is used for requesting to dial a target contact; and
the determining a first subscriber identity module card in the electronic device based on a historically successful call card selection status of the electronic device comprises:
determining a subscriber identity module card used by the electronic device for a most recent successful call with the target contact as the first subscriber identity module card.
